(19) United States
(12) Patent Application Publication
(10) Pub. No.: US 2011/0102923 A1
(43) Pub. Date: May 5, 2011

(54) MIRROR HEAD WITH OVERLAPPING FIELD OF VIEW

(76) Inventors: Werner Lang, Ergersheim (DE); Elmar Finkenberger, Adelshofen (DE); Stefan Centmayer, Ergersheim (DE)

(21) Appl. No.: 12/913,930

(22) Filed: Oct. 28, 2010

(30) Foreign Application Priority Data
Oct. 29, 2009 (DE) 102009046174.4

(51) Int. Cl. B60R 1/08

(52) U.S. Cl. 359/865; 359/866

(57) ABSTRACT

A coupling between a primary mirror and additional mirror so that adjustment of at least one of said mirrors is executed in a way that their fields of view overlap or directly juxtapose. In doing so, the occurrence of a gap in the coverage of the fields of view in the border area shared between mirrors is avoided for the user.

### BACKGROUND OF THE INVENTION

1) Field of the Invention

The present invention relates to a mirror head, and more particularly, to a mirror head carried on a vehicle exterior and having an arrangement of mirrors with overlapping fields of view.

2) Description of Related Art

Due to legal requirements regarding the fields of view using exterior mirrors on commercial vehicles, a primary mirror and at least one smaller additional mirror with differing fields of view are often arranged in one common housing. One such outside mirror, for example, is shown in EP 1020327 B1.

Generally, at least the primary mirror is manually or electronically adjustable. As a result of the adjustability of the larger primary mirror, an unfavorable adjustment of the primary mirror can be performed so that an invisible gap in the field of view results between the field of view of the primary mirror and field of view of the additional mirror. Since both mirrors are arranged directly juxtaposed, the user implicitly assumes that an object in the edge area shared by both mirrors will disappear from the primary mirror and immediately appear in the additional mirror and vice versa. The user is often unaware that an invisible gap in the field of view between the fields of view of the primary mirror and the additional mirror may occur as a result of an unfavorable position of the primary mirror in relation to the additional mirror. Therefore, the user is also not aware that an object in this gap in the fields of view is invisible to him under these conditions. This is even more so the case if the additional mirror is also manually or electronically adjustable.

Accordingly, it is the object of the present invention to provide a mirror head with a plurality of mirrors for a vehicle exterior, in which gaps in the field of view cannot occur in the border areas shared by the plurality of mirrors.

It is a further object of the present invention to provide mirror head with a plurality of adjustable mirrors in which all the mirrors are linked together to move in unison to maintain a cohesive field of view between adjacent mirrors.

### SUMMARY OF THE INVENTION

The above objectives are accomplished according to the present invention by providing a fixed connection between the primary mirror and additional mirror so that the additional mirror is arranged in a fixed location and orientation relative to the primary mirror and is thus automatically adjusted with the adjustment of the primary mirror. The arrangement of the fixed connection between the primary and additional mirrors is executed in a way that their fields of view overlap or directly juxtapose. In doing so, the occurrence of a gap in the coverage of the fields of view in the border area shared between mirrors is avoided for the user.

In one embodiment of the invention, a fixed mechanical coupling of the primary and additional mirrors is realized by connecting the primary and additional mirrors in a common housing and allowing for the housing to be adjusted mechanically using a motor-driven adjusting device, typically referred to as a “head adjuster”.

In a further embodiment of the invention, the primary mirror and additional mirror are arranged on a common mirror carrier plate in the mirror head housing. The primary and additional mirror have a fixed connection to the carrier plate. The adjusting device clamps onto the common mirror carrier plate so no gap in coverage of the fields of view between the mirrors will occur.

In a further embodiment, it is also possible to have an electronic coupling of the operational positions of the primary and additional mirrors, in place of a fixed mechanical connection of the primary and additional mirrors. Permitted and unpermitted positions for the primary mirror are saved in a control device connected to the adjusting device of the primary mirror. If an attempt is made to adjust the primary mirror to a position that is unpermitted, this adjustment is not executed and the primary mirror is only adjusted to a position where an overlapping field of view exists or both fields of view are directly juxtaposed.

In a further embodiment, permitted and unpermitted positions are saved in the control device in the same manner if the additional mirror is independently adjustable by a motorized adjustment device.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a view of the mirror surface, one of the first embodiments of the invention with a primary mirror and an additional mirror;

FIG. 2 shows a sectioning along line A-A in FIG. 1;

FIG. 3 shows a rear view of the mirror head in FIG. 1;

FIG. 4 shows a diagram of the fields of view of the primary and additional mirrors;

FIG. 5 shows a diagram of a second embodiment of the invention;

FIG. 6 shows a diagram of a third embodiment of the invention;

FIG. 7 shows a diagram of a fourth embodiment of the invention; and,

FIG. 8 shows a table explaining the four embodiments of the invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail.

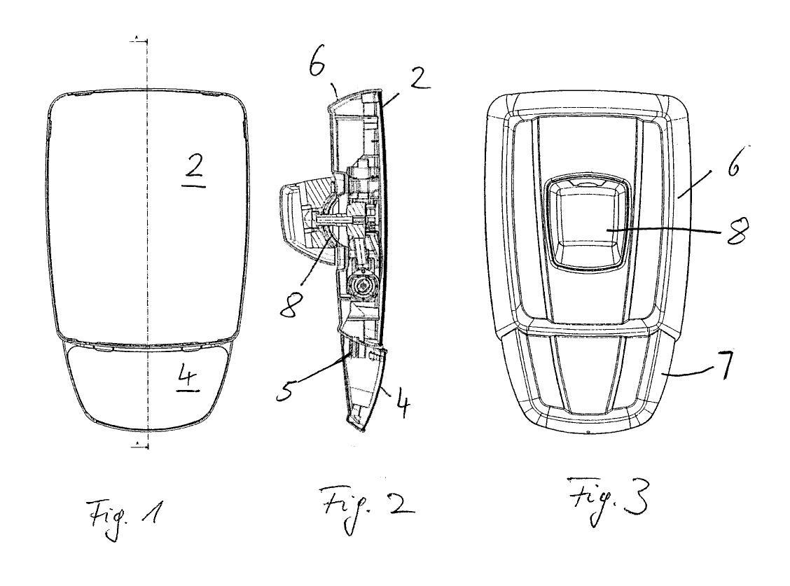

FIGS. 1-3 show a first embodiment of a mirror head. The mirror head includes a primary mirror 2 with a trapezoidal mirror surface with rounded edges as well as an additional mirror 4, which is connected directly to one of the short sides of the primary mirror 2. A bolted connection 5 forms a fixed connection between the additional mirror 4 and primary mirror 2. The primary mirror 2 is arranged in a first housing 6 and the additional mirror 4 is arranged in a second housing 7, which is fixed to first housing 6 by bolted connection 5. An electric motor adjusting device 8 clamps onto the first housing 6 and is operatively associated with primary mirror 2. Based on the fixed connection between the primary mirror 2 and additional mirror 4, the primary mirror 2 and additional mirror 2 are adjusted in unison by operating the adjusting device 8.

Referring now to FIG. 4, a diagram of a tractor 10 is shown with a left outside rearview mirror 12 and a right outside rearview mirror 14, both of which are equipped with a mirror head according to the first embodiment of the present invention shown in FIGS. 1-3. The primary mirror 2 has a primary mirror field of view 16 and the additional mirror 4 has an additional mirror field of view 18. The size and position of these fields of view 16, 18 are shown in FIG. 4. The prior legally required field of view is designated as 16′ for an exterior rearview mirror on a commercial vehicle. The larger, currently required field of view of the primary mirror is designated as 16. Both mirrors 2 and 4 are screwed together in a defined arrangement such that the fields of view 16, 18 of both mirrors 2 and 4 overlap in a cross-sectional area 17 so that an invisible gap in the fields of view does not occur between the fields of view 16 and 18 of both mirrors 2 and 4.

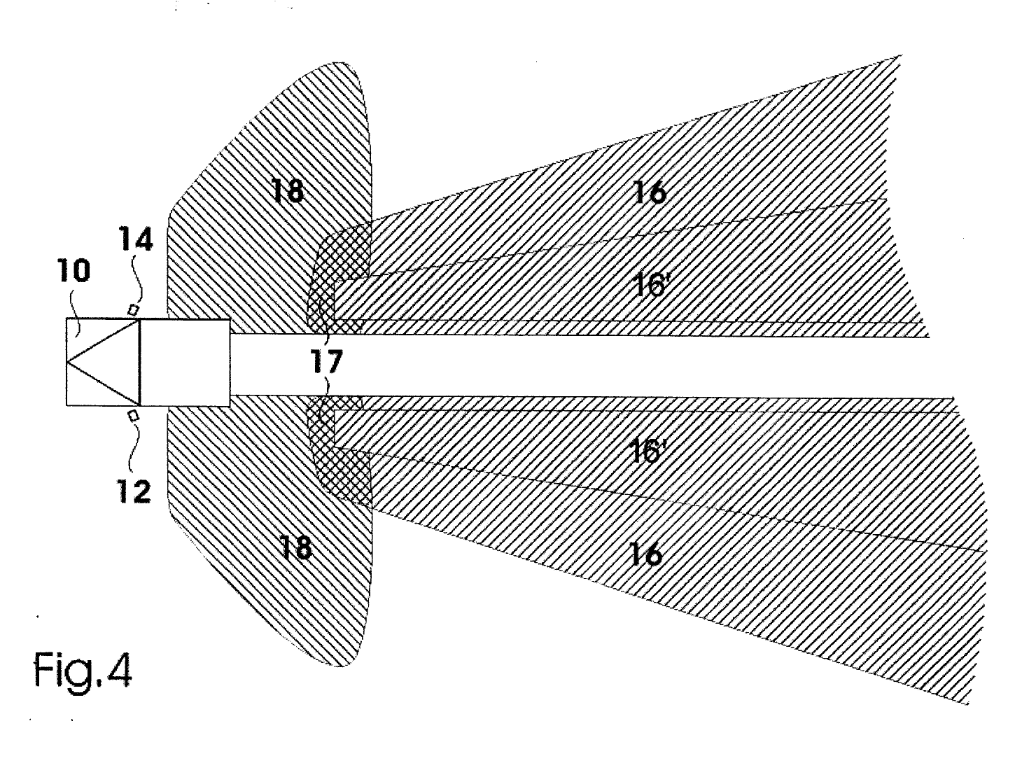

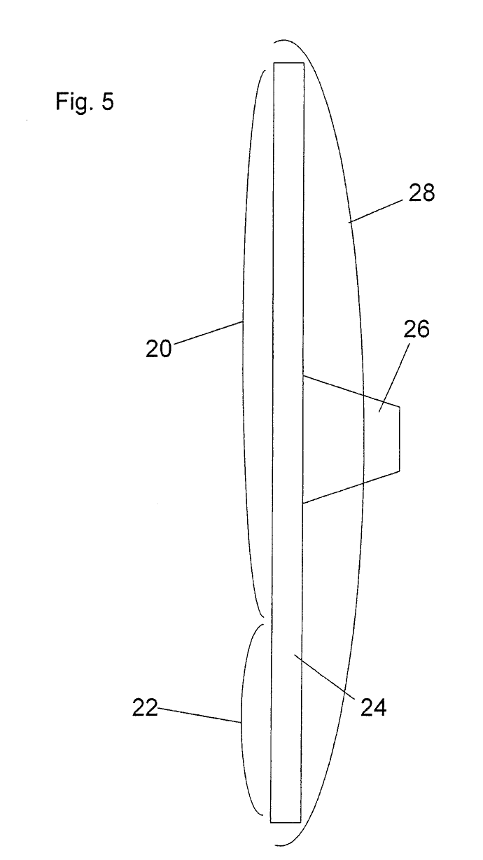

FIG. 5 shows a diagram of a sectioning analogous to FIG. 2, but directed to a second embodiment of the invention in the form of a so-called glass adjuster, whereby a primary mirror 20 and an additional mirror 22 are arranged on a single common carrier plate. An adjusting device 26 clamps onto the common carrier plate so that in turn the mirrors 20 and 22, which are connected to the carrier plate 26 are adjusted together in fixed relation. A common mirror housing 28 is provided for covering the common carrier plate 24. In this arrangement, movement of the common carrier plate 26 causes primary mirror 20 and additional mirror 22 to move in unison.

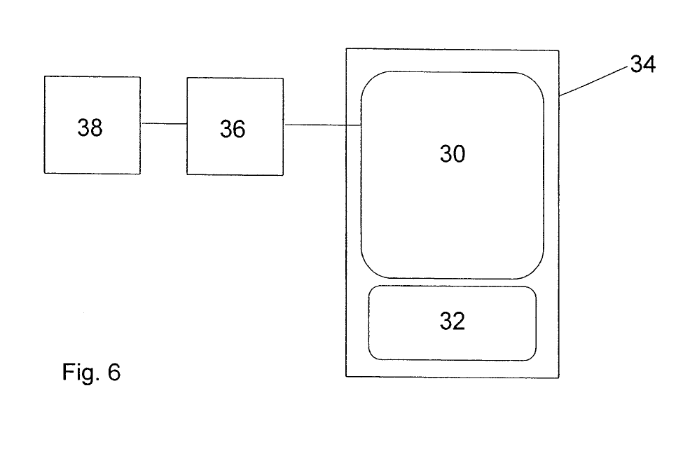

In place of the fixed mechanical coupling between the primary and additional mirrors as discussed above, the coupling of both mirrors can also occur electronically according to a further embodiment of the invention. For this purpose, FIG. 6 is in the form of a block diagram and illustrates a primary mirror 30 and an additional mirror 32 arranged in a common housing 34, one mirror immediately above the other. Primary mirror 30 is adjustable using a primary mirror adjusting device 36, for example, an electric motor operatively associated with a carrier plate on which primary mirror 30 is mounted. The additional mirror 32 is in a fixed connection to the common housing 34 in a specific orientation. The adjusting device 36 is in operative communication with a control device 38. A memory component in the control device 38 digitally saves all possible adjustment positions of the primary mirror 30. A value is assigned and saved for each of these possible positions, indicating whether the position is permitted or unpermitted. Whether the respective position is permitted or not is based on whether or not a gap in the fields of view results between primary mirror 30 and the additional mirror 32 when an adjustment to this respective position is made. The adjustment position is not permitted if a gap in the fields of view occurs. The position is permitted if no gap in the fields of view occurs between primary mirror 30 and additional mirror 32.

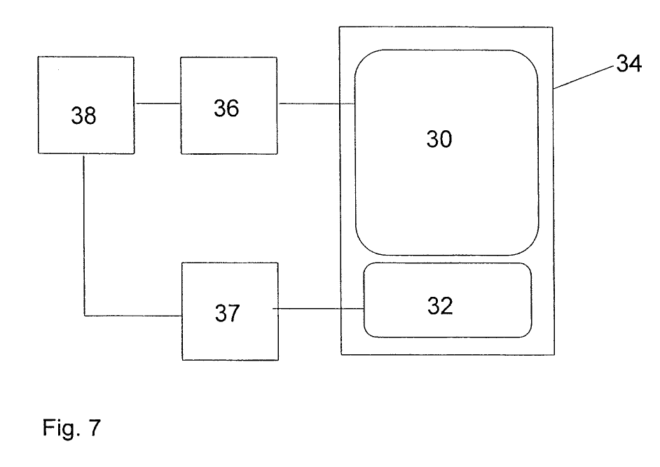

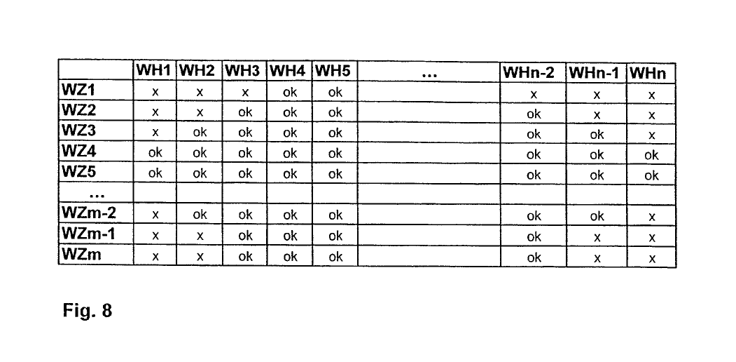

FIG. 7 is a diagram of a further embodiment of the invention analogous to the embodiment represented in FIG. 6, but differs in that an additional mirror adjusting device, for example and electric motor operatively associated with a carrier plate on which additional mirror 32 is mounted, is provided for remote adjustment of the additional mirror. The additional mirror adjusting device 37 is likewise connected to the control device 38. All possible positions W_{Hn} of the primary mirror 30 and all possible positions W_{Zm} of the additional mirror 32 are saved in the form of a matrix, as represented in the table in FIG. 8. The primary mirror 30 positions W_{Hn} make up the column names and the additional mirror 32 positions W_{Zm} make up the row names of this matrix. It is noted in the individual matrix cells whether the respective position combination W_{Hn}/W_{Zm} is permitted—ok—or not—x—. A single position of both mirrors is in turn permitted if no gap in the fields of view occurs for the common border area. The position is not permitted if a gap in the fields of view occurs.

While a preferred embodiment of the invention has been described using specific terms, such description is for illustrative purposes only, and it is to be understood that changes and variations may be made without departing from the spirit or scope of the following claims.

Reference number listing:

2 Primary mirror

4 Additional mirror

5 Bolted connection

6 Primary mirror housing

7 Additional mirror housing

8 Common adjusting device

10 Tractor

12 Left outside mirror

14 Right outside mirror

16 Primary mirror field of view (current)

16′ Primary mirror field of view (former)

17 Overlap area

18 Additional mirror field of view

20 Primary mirror

22 Additional mirror

24 Common glass carrier plate

26 Common adjusting device

28 Common housing

30 Primary mirror

32 Additional mirror

34 Common housing

36 Primary mirror adjusting device

37 Additional mirror adjusting device

38 Control device

What is claimed is:

1. A exterior vehicle mirror head comprising:
a primary mirror having a primary mirror field of view;
at least one additional mirror having a fixed location and orientation relative to said primary mirror and having an additional mirror field of view directly adjacent or partially overlapping with said primary mirror field of view, wherein no gaps in coverage of the fields of view exist between said primary mirror field of view and said additional mirror field of view; and,
an adjusting device operatively associated with said primary mirror for adjusting a position of said primary mirror, wherein movement of said primary mirror causes simultaneous movement of said additional mirror resulting from said fixed orientation to said primary mirror to maintain a predefined orientation of said primary mirror to said additional mirror to prevent gaps in fields of view between the mirrors during adjustment of said primary mirror field of view.

2. The mirror head of claim 1 wherein said primary mirror and said additional mirror are mounted to a common mirror housing in a fixed orientation.

3. The mirror head of claim 2 wherein said adjusting device is operatively connected to said common mirror housing for simultaneously adjusting the position of said primary mirror and said additional mirror.

4. The mirror head of claim 1 wherein said primary mirror and said additional mirror are mounted in a fixed orientation to a common carrier plate within a mirror housing.

5. The mirror head of claim 4 wherein said adjusting device is operatively connected to said common carrier plate for simultaneously adjusting the position of said primary mirror and said additional mirror.

6. The mirror head of claim 1 wherein said primary mirror is carried in a fixed orientation within a first mirror housing, and said additional mirror is carried in a fixed orientation within a second mirror housing, wherein said second mirror housing is affixed to said first mirror housing.

7. The mirror head of claim 6 wherein said adjusting device is operatively connected to said first mirror housing for simultaneously adjusting the position of said primary mirror and said additional mirror.

8. A exterior vehicle mirror head comprising:
an adjustable primary mirror having a primary mirror field of view;
at least one additional mirror arranged adjacent to said primary mirror having an additional mirror field of view;
an adjusting device operatively associated with said primary mirror for adjusting the position of said primary mirror; and,
a control device operatively connected to said adjusting device that only permits an adjustment of said primary mirror that directly juxtaposes or overlaps the fields of view of said primary mirror and said additional mirror.

9. The mirror head of claim 8, including an additional mirror adjusting device operatively connected to said control device for adjusting said additional mirror that only permits an adjustment of said additional mirror relative to said primary mirror that directly juxtaposes or overlaps their fields of view.

10. The mirror head of claim 8, wherein said primary mirror and said additional mirror having different radii of curvature.

11. The mirror head of claim 8, wherein said primary mirror and said additional mirror are aspherical.

12. The mirror head of claim 8 wherein said primary mirror and said additional mirror are mounted in a common mirror housing.

13. A method for controlling mirrors in an exterior vehicle mirror head comprising the steps of:
providing an adjustable primary mirror having a primary mirror field of view;
storing position information as to all possible adjustment positions of said primary mirror in a memory unit;
providing at least one additional mirror arranged adjacent to said primary mirror having an additional mirror field of view;
assigning a value for each of said adjustment positions indicating whether the position is permitted or unpermitted based on whether the respective adjustment position results in a gap in the fields of view between said primary mirror and said additional mirror; and,
controlling adjustment of said primary mirror so that said primary mirror is only adjustable to a permitted position that directly juxtaposes or overlaps the fields of view of said primary mirror and said additional mirror so that no gap in coverage exists between said primary mirror and said additional mirror.

14. The method of claim 13 including the steps of providing an adjustable additional mirror.

15. The method of claim 14 including the steps of storing position information as to all possible adjustment positions of said adjustable additional mirror in a memory unit in the form of a matrix with said position information of said primary mirror.

16. The method of claim 15 including the steps of assigning a value for each of said adjustment positions of said adjustable additional mirror indicating whether the position is permitted or unpermitted based on whether the respective adjustment position results in a gap in the fields of view between said primary mirror and said additional mirror.

17. The method of claim 15 including the steps of controlling adjustment of said adjustable additional mirror so that said adjustable additional mirror is only adjustable to a permitted position that directly juxtaposes or overlaps the fields of view of said primary mirror and said additional mirror so that no gap in coverage exists between said primary mirror and said adjustable additional mirror.
